(19) United States
(12) Patent Application Publication
(10) Pub. No.: US 2008/0161521 A1
(43) Pub. Date: Jul. 3, 2008

(54) PRODUCTION METHOD OF INSULATING FILM FORMING COMPOSITION, INSULATING FILM FORMING COMPOSITION PRODUCED BY THE PRODUCTION METHOD, INSULATING FILM AND ELECTRONIC DEVICE

(75) Inventor: Haruki INABE, Haibara-gun (JP)

Correspondence Address: SUGHRUE-265550, 2100 PENNSYLVANIA AVE. NW, WASHINGTON, DC, 20037-3213, US

(73) Assignee: FUJIFILM Corporation, Tokyo (JP)

(21) Appl. No.: 11/859,860

(22) Filed: Sep. 24, 2007

(30) Foreign Application Priority Data
Sep. 22, 2006 (JP) 2006-257963

(51) Int. Cl. C08G 77/04

(52) U.S. Cl. 526/279

(57) ABSTRACT

A production method of an insulating film forming composition includes a process of filtering a composition through a filter made of polyethylene or nylon.

### BACKGROUND OF THE INVENTION

1. Field of the Invention

The present invention relates to a production process of a composition for forming an insulating film for use in semiconductor devices and the like and good in film properties such as dielectric constant, mechanical strength and heat resistance. More specifically, the invention relates to an insulating film forming composition produced by the production process, an insulating film available using the composition, and an electronic device having the insulating film.

2. Description of the Related Art

In recent years, with the progress of high integration, multifunction and high performance in the field of electronic materials, circuit resistance and condenser capacity between interconnects have increased and have caused an increase in electric power consumption and delay time. Particularly, the increase in delay time becomes a large factor for reducing the signal speed of devices and generating crosstalk. Reduction of parasitic resistance and parasitic capacity are therefore required in order to reduce this delay time, thereby attaining speed-up of devices. As one of the concrete measures for reducing this parasitic capacity, an attempt has been made to cover the periphery of an interconnect with a low dielectric interlayer insulating film. The interlayer insulating film is expected to have superior heat resistance in the thin film formation step when a printed circuit board is manufactured or in post steps such as chip connection and pin attachment and also chemical resistance in the wet process. In addition, a low resistance Cu interconnect has been introduced in recent years instead of an Al interconnect, and along with this, CMP (chemical mechanical polishing) has been employed commonly for planarization of the film surface. Accordingly, an insulating film having high mechanical strength and capable of withstanding this CMP step is required.

Materials for forming an interlayer insulating film having a low dielectric constant and excellent mechanical strength are disclosed in U.S. Patent Application Publication No. 2005/0276964 A1 or the like. There is however a room for improvement in their insulation properties which have a large influence on the reliability or the like of electronic devices produced using the interlayer insulating film material.

### SUMMARY OF THE INVENTION

The invention provides a production process of a composition for forming an insulating film excellent in insulation properties such as leak current and breakdown voltage and good in film properties such as mechanical strength and heat resistance without impairing a low dielectric constant of the film. The invention also provides an insulating film forming composition produced by the production process, an insulating film available using the composition, and an electronic device having the insulating film. An “insulating film” is also referred to as a “dielectric film” or a “dielectric insulating film”, and these terms are not substantially distinguished.

The present inventors have found that the above-described problems can be overcome by the following constitutions <1> to <12>.

<1> A production method of an insulating film forming composition, comprising:

a process of filtering a composition through a filter made of polyethylene or nylon.

<2> The production method as described in <1>,

wherein the filter is made of nylon 66.

<3> The production method as described in <1>,

wherein the composition to be filtered comprises an organic polymer.

<4> The production method as described in <1>,

wherein the composition to be filtered comprises (A) at least one kind of polymer comprising a repeating unit having a cage structure.

<5> The production method as described in <4>,

wherein each of the at least one kind of polymer (A) is derived from a monomer having a cage structure having a polymerizable carbon-carbon double bond or carbon-carbon triple bond.

<6> The production method as described in <4>,

wherein the cage structure is selected from the group consisting of adamantane, biadamantane, diamantane, triamantane, tetramantane and dodecahedrane.

<7> The production method as described in <5>,

wherein the monomer having a cage structure is selected from the group consisting of compounds represented by the following formulas (I) to (VI):

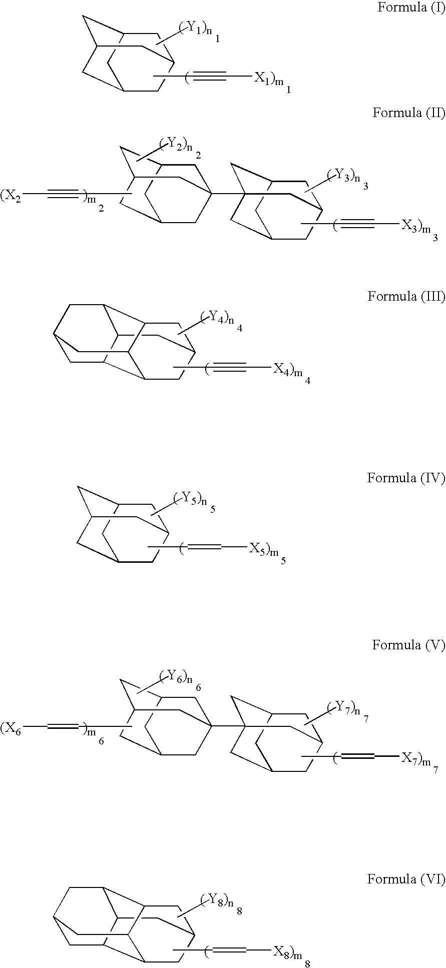

wherein, X₁(s) to X₈(s) each independently represents a hydrogen atom, C₁₋₁₀ alkyl group, C₂₋₁₀ alkenyl group, C₂₋₁₀ alkynyl group, C₆₋₂₀ aryl group, C₀₋₂₀ silyl group, C₂₋₁₀ acyl group, C₂₋₁₀ alkoxycarbonyl group, or C₁₋₂₀ carbamoyl group;

Y₁ to Y₈ each independently represents a halogen atom, C₁₋₁₀ alkyl group, C₆₋₂₀ aryl group or C₀₋₂₀ silyl group;

m₁ and m₅ each represents an integer of 1 to 16,

n₁ and n₅ each represents an integer of 0 to 15,

m₂, m₃, m₆ and m₇ each independently represents an integer of 1 to 15,

n₂, n₃, n₆ and n₇ each independently represents an integer of from 0 to 14,

m₄ and m₈ each independently represents an integer of 1 to 20, and

n₄ and n₈ each represents an integer of 0 to 19.

<8> The production method as described in <4>,

wherein the cage structure is formed by linking each of m pieces of RSi(O_{0.5})₃ units with other RSi(O_{0.5})₃ units by sharing the oxygen atoms,

wherein m represents an integer from 8 to 16; and

each of Rs represents a non-hydrolyzable group, with the proviso that each of at least two Rs represents a group having a vinyl group or ethynyl group.

<9> The production method as described in <8>,

wherein the monomer having a cage structure is selected from the group consisting of compounds represented by the following formulas (Q-1) to (Q-6):

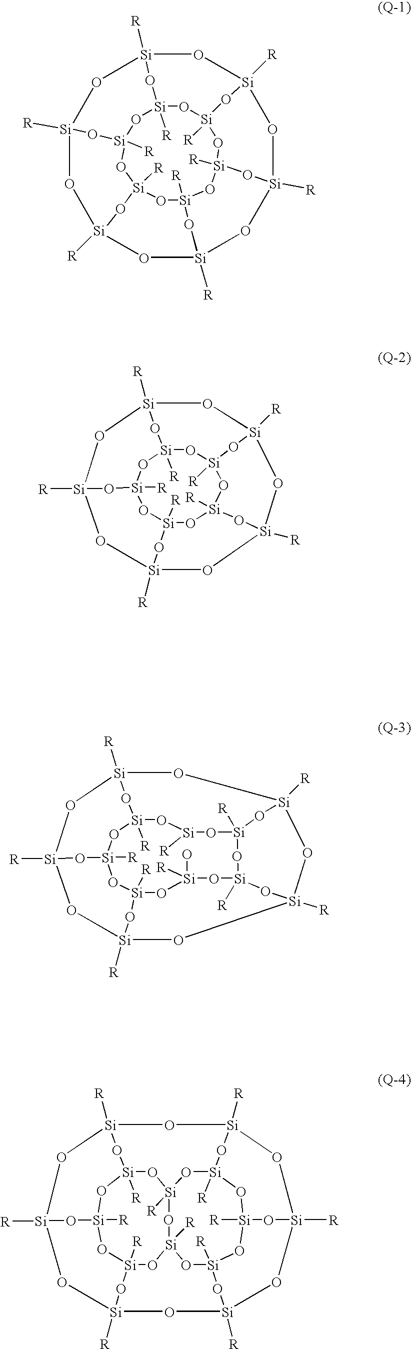

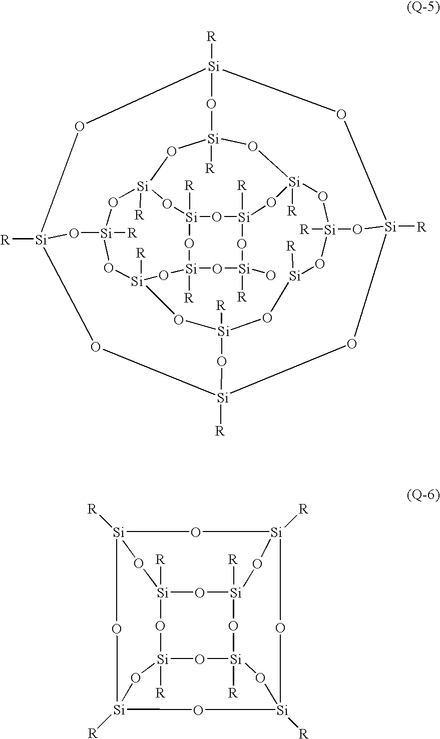

wherein each of Rs represents a non-hydrolyzable group, with the proviso that each of at least two Rs in each of formulas (Q-1) to (Q-6) represents a group having a vinyl group or ethynyl group.

<10> An insulating film forming composition produced by the production method as described in <1>.

<11> An insulating film formed by using the insulating film forming composition as described in <10>.

<12> An electronic device comprising the insulating film as described in <11>.

### DETAILED DESCRIPTION OF THE INVENTION

The present invention will hereinafter be described specifically.

The process for producing an application type interlayer insulating film according to the invention has at least a step of filtering through a filter made of polyethylene (PE) or nylon. The filter is made of preferably nylon 66.

A reason why in the insulating film forming composition of the invention produced by a process including a step of filtering through a filter made of PE or nylon (preferably, nylon 66), insulation properties which will have an influence on the reliability of a device to be manufactured are improved is presumed to be as follows.

It is conventionally known that an insulating film forming composition is prepared by a process including a step of filtering a filter made of polytetrafluoroethylene (PTFE). A description on it can be found, for example, in Examples of US Patent Application Publication No. 2005/0276964A1. Although a filter made of a material having a relatively low polarity such as PTFE can easily filter off impurities having a physical size greater than the size of the filter, it hardly removes impurities such as low molecular components or ionic components having a high polarity because they easily pass through the filter.

A filter made of a material having a relatively high polarity such as polyethylene (PE) or nylon is, on the other hand, presumed to be effective for removing impurities—such as low molecular components or ionic components having a high polarity—chemically adsorbed to the material of the filter during the passage of the composition through the pores of the filter. The insulating film forming composition from which the low molecular components and ionic components having a high polarity have been filtered off is therefore presumed to have improved insulation properties such as leak current and breakdown voltage.

Although the filter to be used for the production of the application type interlayer insulating film forming composition of the invention is not particularly limited insofar as it is made of PE or nylon, the filter has preferably a pore size of from 0.05 μm or less, more preferably 0.02 μm or less.

Insofar as at least one step of filtering through a filter made of PE or nylon is performed in the production of the application type interlayer insulating film forming composition of the invention, a plurality of filters including a filter made of a material other than PE or nylon may be used in combination. For example, pre-filtration through a PTFE filter having a large pore size may be followed by main filtration through a PE or nylon filter having a smaller pore size. Alternatively, pre-filtration through a PE or nylon filter having a large pore size may be followed by main filtration through a PE or nylon filter having a smaller pore size.

Materials which can be contained in the application type interlayer insulating film forming composition of the invention will next be described specifically, but the present invention is not limited to the below-described examples.

### Polymer

The application type interlayer insulating film forming composition of the invention contains preferably at least one polymer. No particular limitation is imposed on the polymer usable in the invention insofar as it can form a film having a low dielectric constant and high mechanical strength. It is preferably an organic polymer. The term “organic polymer” as used herein means a polymer having, as the skeleton of the main chain thereof, only C, O, N, and H.

Examples of the organic polymer usable in the invention include polybenzoxazoles as described in JP-A-1999-322929 (the term “JP-A” as used herein means an unexamined published Japanese patent application), JP-A-2003-12802, and JP-A-2004-18593, quinoline resins as described in JP-A-2001-2899, polyaryl resins as described in JP-T-2003-530464 (the term “JP-T” as used herein means a published Japanese translation of a PCT patent application), JP-T-2004-535497, JP-T-2004-504424, JP-T-2004-504455, JP-T-2005-501131, JP-T-2005-516382, JP-T-2005-514479, JP-T-2005-522528, JP-A-2000-100808 and U.S. Pat. No. 6,509,415, polyadamantanes as described in JP-A-1999-214382, JP-A-2001-332542, JP-A-2003-252982, JP-A-2003-292878, JP-A-2004-2787, JP-A-2004-67877 and JP-A-2004-59444, and polyimides as described in JP-A-2003-252992 and JP-A-2004-26850.

The insulating film forming composition of the invention contains preferably at least one polymer (A) having a repeating unit containing a cage structure.

The term “cage structure” as used herein means a molecule whose space is defined by a plurality of rings formed by covalent-bonded atoms and a point existing within the space cannot depart from the space without passing through these rings. For example, an adamantane structure may be considered as the cage structure. Contrary to this, a single crosslink-having cyclic structure such as norbornane (bicyclo[2,2,1]heptane) cannot be considered as the cage structure because the ring of the single-crosslinked cyclic compound does not define the space of the compound.

Preferred examples of the cage structure of the invention include alicyclic hydrocarbon structures (which will hereinafter be called “cage structure (a)”) such as adamantane, biadamantane, diamantane, triamantane, tetramantane, and dodecahedrane, and structures formed by the linkage of each of m pieces of RSi(O_{0.5})₃ units (wherein m stands for an integer from 8 to 16 and Rs each independently represents a non-hydrolyzable group with the proviso that at least two of the Rs each represents a vinyl- or ethynyl-containing group) to another RSi(O_{0.5})₃ unit via an oxygen atom possessed in common (which will hereinafter be called “cage structure (b)”).

Examples of the cage structure (a) include adamantane, biadamantane, diamantane, triamantane, tetramantane, and dodecahedrane. Of these, adamantane, biadamantane and diamantane are more preferred, with biadamantane and diamantane being especially preferred, because they have a low dielectric constant.

The cage structure (a) according to the invention may have one or more substituents. Examples of the substituents include halogen atoms (fluorine, chlorine, bromine and iodine), linear, branched or cyclic C₁₋₁₀ alkyl groups (such as methyl, t-butyl, cyclopentyl and cyclohexyl), C₂₋₁₀ alkenyl groups (such as vinyl and propenyl), C₂₋₁₀ alkynyl groups (such as ethynyl and phenylethynyl), C₆₋₂₀ aryl groups (such as phenyl, 1-naphthyl and 2-naphthyl), C₂₋₁₀ acyl groups (such as benzoyl), C₂₋₁₀ alkoxycarbonyl groups (such as methoxycarbonyl), C₁₋₁₀ carbamoyl groups (such as N,N-diethylcarbamoyl), C₆₋₂₀ aryloxy groups (such as phenoxy), C₆₋₂₀ arylsulfonyl groups (such as phenylsulfonyl), nitro group, cyano group, and silyl groups (such as triethoxysilyl, methyldiethoxysilyl and trivinylsilyl).

In the preparation of the polymer (A), the polymerization reaction of the monomer having the cage structure (a) is caused by a polymerizable group substituted to the monomer. The term “polymerizable group” as used herein means a reactive substituent that causes polymerization of a monomer. Although any polymerization reaction can be employed, examples include radical polymerization, cationic polymerization, anionic polymerization, ring-opening polymerization, polycondensation, polyaddition, addition condensation and polymerization in the presence of a transition metal catalyst.

The polymerization reaction of the monomer having the cage structure (a) in the invention is carried out preferably in the presence of a non-metallic polymerization initiator. For example, a monomer having a polymerizable carbon-carbon double bond or carbon-carbon triple bond can be polymerized in the presence of a polymerization initiator that generates, by heating, a free radical such as carbon radical or oxygen radical and shows activity.

As the polymerization initiator, organic peroxides and organic azo compounds are preferred, of which organic peroxides are especially preferred.

Preferred examples of the organic peroxides include ketone peroxides such as “PERHEXA H”, peroxyketals such as “PERHEXA TMH”, hydroperoxides such as “PERBUTYL H-69”, dialkylperoxides such as “PERCUMYL D”, “PERBUTYL C” and “PERBUTYL D”, diacyl peroxides such as “NYPER BW”, peroxy esters such as “PERBUTYL Z” and “PERBUTYL L”, and peroxy dicarbonates such as “PEROYL TCP”, (each, trade name; commercially available from NOF Corporation), diisobutyryl peroxide, cumylperoxyneodecanoate, di-n-propylperoxydicarbonate, diisopropylperoxydicarbonate, di-sec-butylperoxydicarbonate, 1,1,3,3-tetramethylbutylperoxyneodecanoate, di(4-t-butylchlorohexyl)peroxydicarbonate, di(2-ethylhexyl)peroxydicarbonate, t-hexylperoxyneodecanoate, t-butylperoxyneodecanoate, t-butylperoxyneoheptanoate, t-hexylperoxypivalate, t-butylperoxypivalate, di(3,5,5-trimethylhexanoyl)peroxide, dilauroyl peroxide, 1,1,3,3-tetramethylbutylperoxy-2-ethylhexanoate, disuccinic acid peroxide, 2,5-dimethyl-2,5-di(2-ethylhexanoylperoxy)hexane, t-hexylperoxy-2-ethylhexanoate, di(4-methylbenzoyl)peroxide, t-butylperoxy-2-ethylhexanoate, di(3-methylbenzoyl)peroxide, benzoyl(3-methylbenzoyl)peroxide, dibenzoyl peroxide, 1,1-di(t-butylperoxy)-2-methylcyclohexane, 1,1-di(t-hexylperoxy)-3,3,5-trimethylcyclohexane, 1,1-di(t-hexylperoxy)cyclohexane, 1,1-di(t-butylperoxy)cyclohexane, 2,2-di(4,4-di-(t-butylperoxy)cyclohexyl)propane, t-hexylperoxyisopropyl monocarbonate, t-butylperoxymaleic acid, t-butylperoxy-3,5,5-trimethylhexanoate, t-butylperoxylaurate, t-butylperoxyisopropylmonocarbonate, t-butylperoxy-2-ethylhexylmonocarbonate, t-hexylperoxybenzoate, 2,5-dimethyl-2,5-di(benzoylperoxy)hexane, t-butylperoxyacetate, 2,2-di-(t-butylperoxy)butane, t-butylperoxybenzoate, n-butyl-4,4-di-t-butylperoxyvalerate, di(2-t-butylperoxyisopropyl)benzene, dicumyl peroxide, di-t-hexyl peroxide, 2,5-dimethyl-2,5-di(t-butylperoxy)hexane, t-butylcumyl peroxide, di-t-butyl peroxide, p-methane hydroperoxide, 2,5-dimethyl-2,5-di(t-butylperoxy)hexine-3, diisopropylbenzene hydroperoxide, 1,1,3,3-tetramethylbutyl hydroperoxide, cumene hydroperoxide, t-butyl hydroperoxide, 2,3-dimethyl-2,3-diphenylbutane, 2,4-dichlorobenzoyl peroxide, o-chlorobenzoyl peroxide, p-chlorobenzoyl peroxide, tris-(t-butylperoxy)triazine, 2,4,4-trimethylpentylperoxyneodecanoate, α-cumylperoxyneodecanoate, t-amylperoxy-2-ethylhexanoate, t-butylperoxyisobutyrate, di-t-butylperoxyhexahydroterephthalate, di-t-butylperoxytrimethyladipate, di-3-methoxybutylperoxydicarbonate, di-isopropylperoxydicarbonate, t-butylperoxyisopropylcarbonate, 1,6-bis(t-butylperoxycarbonyloxy)hexane, diethylene glycol bis(t-butylperoxycarbonate) and t-hexylperoxyneodecanoate.

Examples of the organic azo compound include azonitrile compounds such as “V-30”, “V-40”, “V-59”, “V-60”, “V-65” and “V-70”, azoamide compounds such as “VA-080”, “VA-085”, “VA-086”, “VF-096”, “VAm-110” and “VAm-111”, cyclic azoamidine compounds such as “VA-044” and “VA-061”, and azoamidine compounds such as “V-50” and VA-057” (each, trade name; commercially available from Wako Pure Chemical Industries), 2,2-azobis(4-methoxy-2,4-dimethylvaleronitrile), 2,2-azobis(2,4-dimethylvaleronitrile), 2,2-azobis(2-methylpropionitrile), 2,2-azobis(2,4-dimethylbutyronitrile), 1,1-azobis(cyclohexane-1-carbonitrile), 1-[(1-cyano-1-methylethyl)azo]formamide, 2,2-azobis{2-methyl-N-[1,1-bis(hydroxymethyl)-2-hydroxyethyl]propionamide}, 2,2-azobis[2-methyl-N-(2-hydroxybutyl)propionamide], 2,2-azobis[N-(2-propenyl)-2-methylpropionamide], 2,2-azobis(N-butyl-2-methylpropionamide), 2,2-azobis(N-cyclohexyl-2-methylpropionamide), 2,2-azobis[2-(2-imidazolin-2-yl)propane]dihydrochloride, 2,2-azobis[2-(2-imidazolin-2-yl)]propane]disulfate dihydrate, 2,2-azobis{2-[1-(2-hydroxyethyl)-2-imidazolin-2-yl]propane}dihydrochloride, 2,2-azobis[2-[2-imidazolin-2-yl]propane], 2,2-azobis(1-imino-1-pyrrolidino-2-methylpropane)dihydrochloride, 2,2-azobis(2-methylpropionamidine)dihydrochloride, 2,2-azobis[N-(2-carboxyethyl)-2-methylpropionamidine]tetrahydrate, dimethyl-2,2-azobis(2-methylpropionate), 4,4-azobis(4-cyanovaleric acid) and 2,2-azobis(2,4,4-trimethylpentane).

The polymerization initiators for the monomer having the cage structure (a) may be used either singly or as a mixture. The amount of it is preferably from 0.001 to 2 moles, more preferably from 0.01 to 1 mole, especially preferably from 0.05 to 0.5 mole, per mole of the monomer.

The polymerization reaction of the monomer having the cage structure (a) in the invention may be effected in the presence of a transition metal catalyst. For example, it is preferred to carry out polymerization of a monomer having a polymerizable carbon-carbon double bond or carbon-carbon triple bond, for example, in the presence of a Pd catalyst such as Pd(PPh₃)₄ or Pd(OAc)₂, a Ziegler-Natta catalyst, an Ni catalyst such as nickel acetyl acetonate, a W catalyst such as WCl₆, an Mo catalyst such as MoCl₅, a Ta catalyst such as TaCl₅, an Nb catalyst such as NbCl₅, an Rh catalyst or a Pt catalyst.

These transition metal catalysts may be used either singly or as a mixture.

The amount of the transition metal catalyst is preferably from 0.001 to 2 moles, more preferably from 0.01 to 1 mole, especially preferably from 0.05 to 0.5 mole per mole of the monomer.

The cage structure (a) in the invention may have been substituted as a pendant group in the polymer (A) or may have become a portion of the main chain of the polymer (A), but latter is preferred. When the cage structure has become a portion of the main chain of the polymer, the polymer chain is broken by the removal of the compound having the cage structure from the polymer. In this state, the cage structure (a) may be linked directly via a single bond or by an appropriate divalent linking group. Example of the linking group include —C(R₁₁)(R₁₂)—, —C(R₁₃)═C(R₁₄)—, —C≡C—, arylene group, —CO—, —O—, —SO₂—, —N(R₁₅)—, and —Si(R₁₆)(R₁₇)—, and combination thereof. In these groups, R₁₁ to R₁₇ each independently represents a hydrogen atom, an alkyl group, an alkenyl group, an alkynyl group or an aryl group. These linking groups may be substituted by a substituent and the above-described substituents are preferably employed as the substituent.

Of these, —C(R₁₁)(R₁₂)—, —CH═CH—, —C≡C—, arylene group, —O— and —Si(R₁₆)(R₁₇)—, and combination thereof are more preferred, with —C(R₁₁)(R₁₂)— and —CH═CH— being especially preferred in consideration of a low dielectric constant.

The polymer (A) having the cage structure (a) in the invention may have a mass average molecular weight of preferably from 1000 to 500000, more preferably from 2000 to 200000, especially preferably from 3000 to 100000.

The polymer (A) having the cage structure (a) according to the invention is preferably a polymer of a monomer having a polymerizable carbon-carbon double bond or carbon-carbon triple bond. The monomer having the cage structure is more preferably a compound selected from the group consisting of compounds represented by the below-described formulas (I) to (VI).

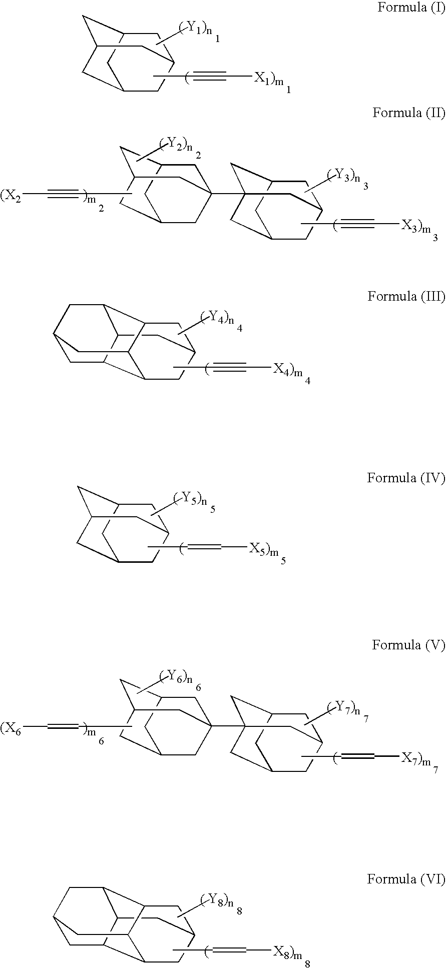

In the formulas (I) to (VI),

X₁(s) to X₈(s) each independently represents a hydrogen atom, a C₁₋₁₀ alkyl group, a C₂₋₁₀ alkenyl group, a C₂₋₁₀ alkynyl group, a C₆₋₂₀ aryl group, a C₀₋₂₀ silyl group, a C₂₋₁₀ acyl group, a C₂₋₁₀ alkoxycarbonyl group, or a C₁₋₂₀ carbamoyl group, of which hydrogen atom, C₁₋₁₀ alkyl group, C₆₋₂₀ aryl group, C₀₋₂₀ silyl group, C₂₋₁₀ acyl group, C₂₋₁₀ alkoxycarbonyl group, or C₁₋₂₀ carbamoyl group is preferred; hydrogen atom or C₆₋₂₀ aryl group is more preferred; and hydrogen atom is especially preferred.

Y₁(s) to Y₈(s) each independently represents a halogen atom, C₁₋₁₀ alkyl group, C₆₋₂₀ aryl group, or C₀₋₂₀ silyl group, of which a C₁₋₁₀ alkyl group or C₆₋₂₀ aryl group which may have a substituent is more preferred and an alkyl (methyl or the like) group is especially preferred.

X₁(s) to X₈(s) and Y₁(s) to Y₈(s) may each be substituted by another substituent.

In the above formulas,

m₁ and m₅ each independently stands for an integer from 1 to 16, preferably an integer from 1 to 4, more preferably from 1 to 3, especially preferably 2;

n₁ and n₅ each independently stands for an integer from 0 to 15; preferably from 0 to 4, more preferably 0 or 1, especially preferably 0;

m₂, m₃, m₆ and m₇ each independently stands for an integer from 1 to 15; preferably from 1 to 4, more preferably 1 to 3, especially preferably 2;

n₂, n₃, n₆ and n₇ each independently stands for an integer from 0 to 14; preferably from 0 to 4, more preferably 0 or 1, especially preferably 0;

m₄ and m₈ each independently stands for an integer from 1 to 20; preferably from 1 to 4, more preferably from 1 to 3, especially preferably 2; and

n₄ and n₈ each independently stands for an integer from 0 to 19, preferably from 0 to 4, more preferably 0 or 1, especially preferably 0.

The monomer having the cage structure (a) according to the invention is preferably a compound represented by the above-described formula (II), (III), (V) or (VI), more preferably a compound represented by the formula (II) or (III), especially preferably a compound represented by the formula (III).

Two or more of the polymers (A) having a repeating unit containing the cage structure (a) of the invention may be used in combination. Alternatively, two or more of the monomers having the cage structure (a) of the invention may be copolymerized.

The polymer (A) of the invention having a repeating unit containing the cage structure (a) preferably has a sufficient solubility in an organic solvent. The solubility at 25° C. in cyclohexanone or anisole is preferably 3 mass % or greater, more preferably 5 mass % or greater, especially preferably 10 mass % or greater.

Specific examples of the monomer having the cage structure (a) and usable in the invention include, but not limited to, the following ones.

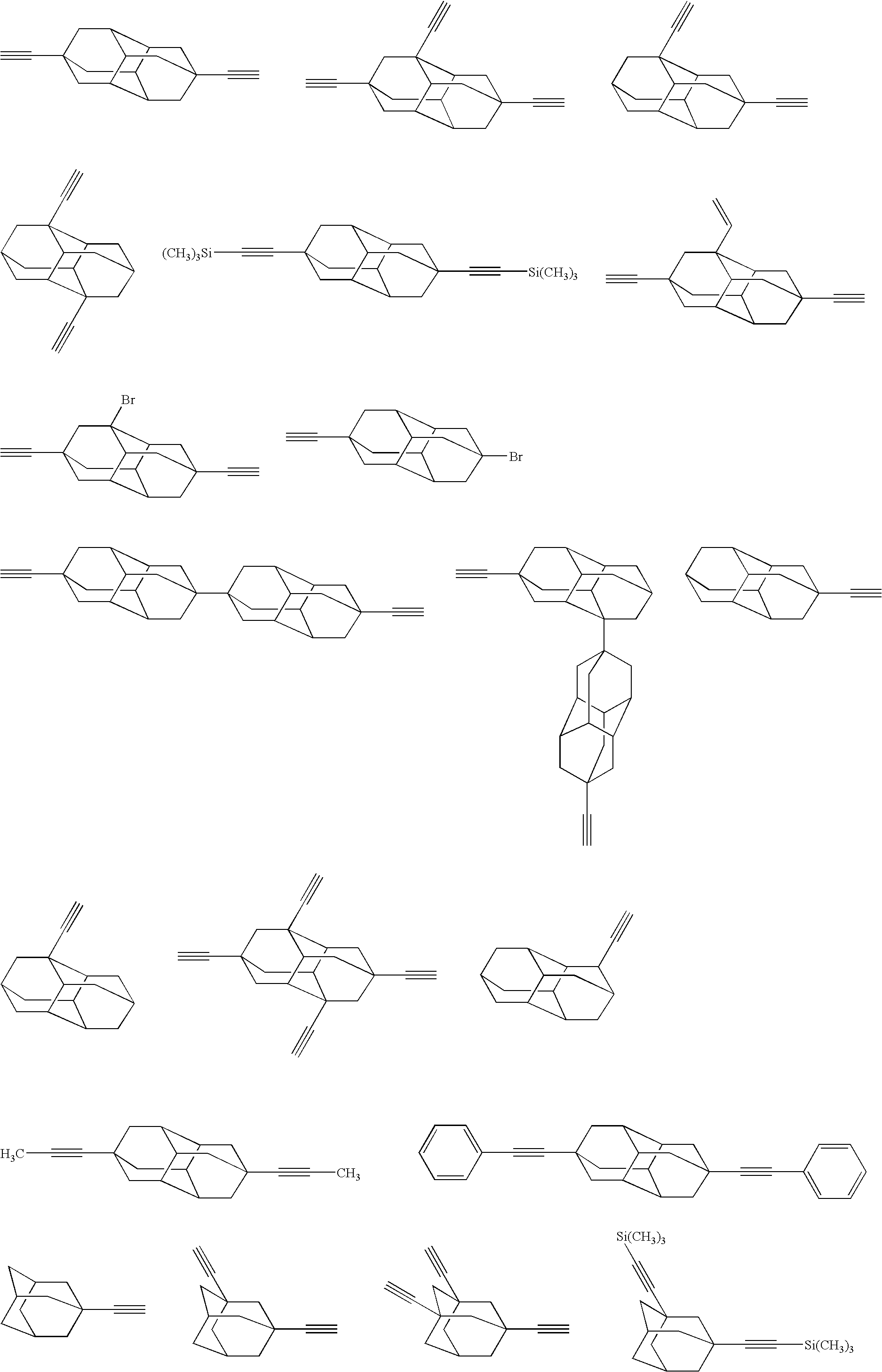

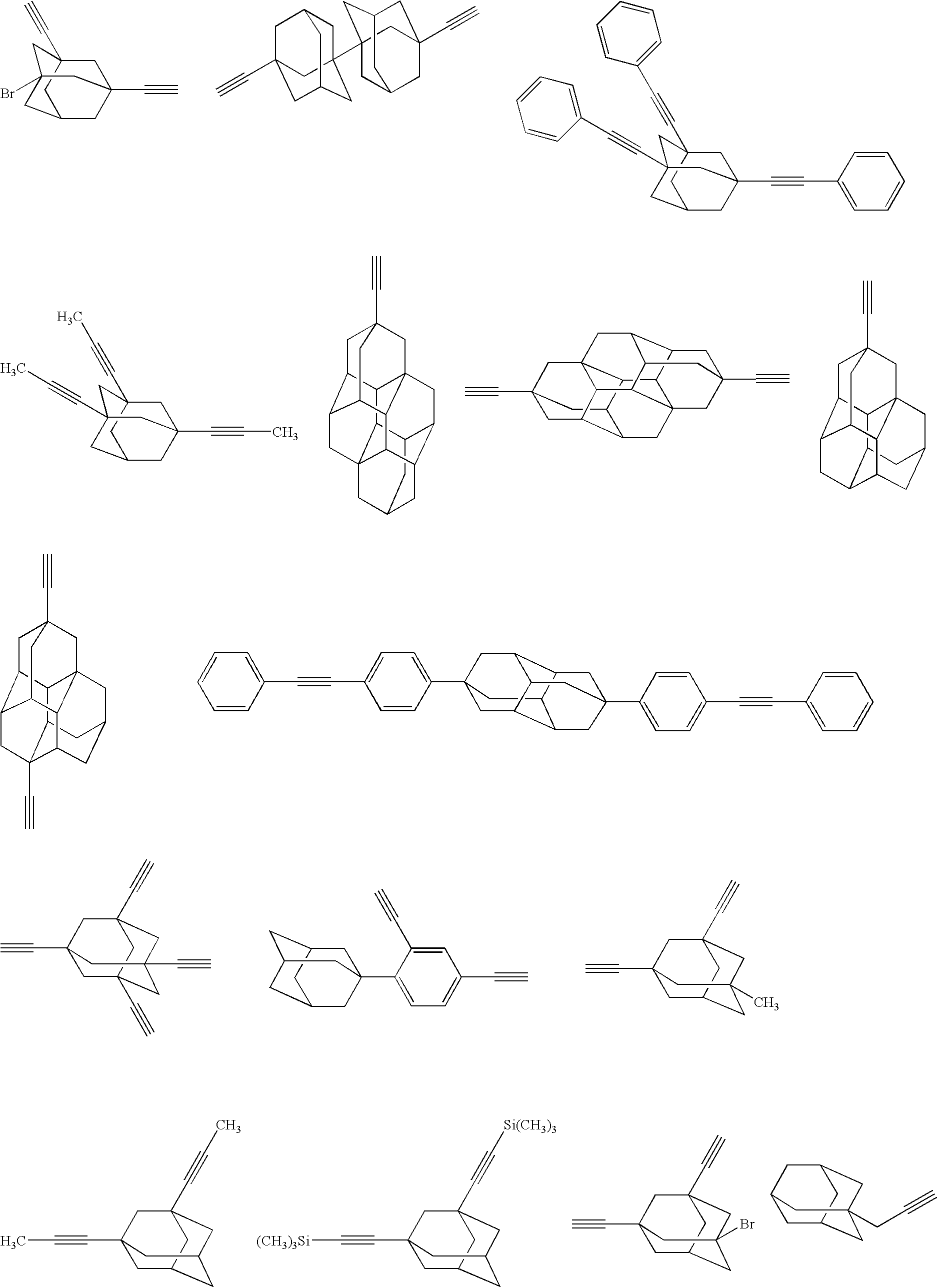

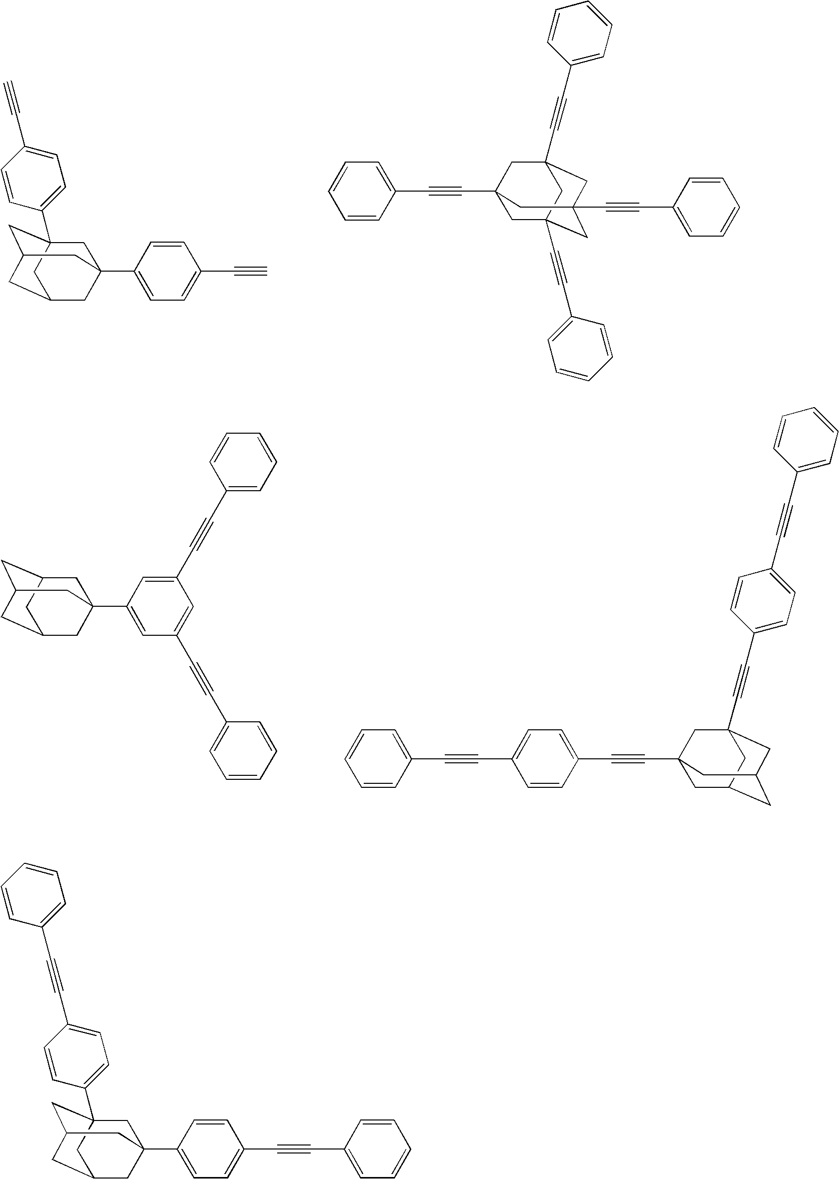

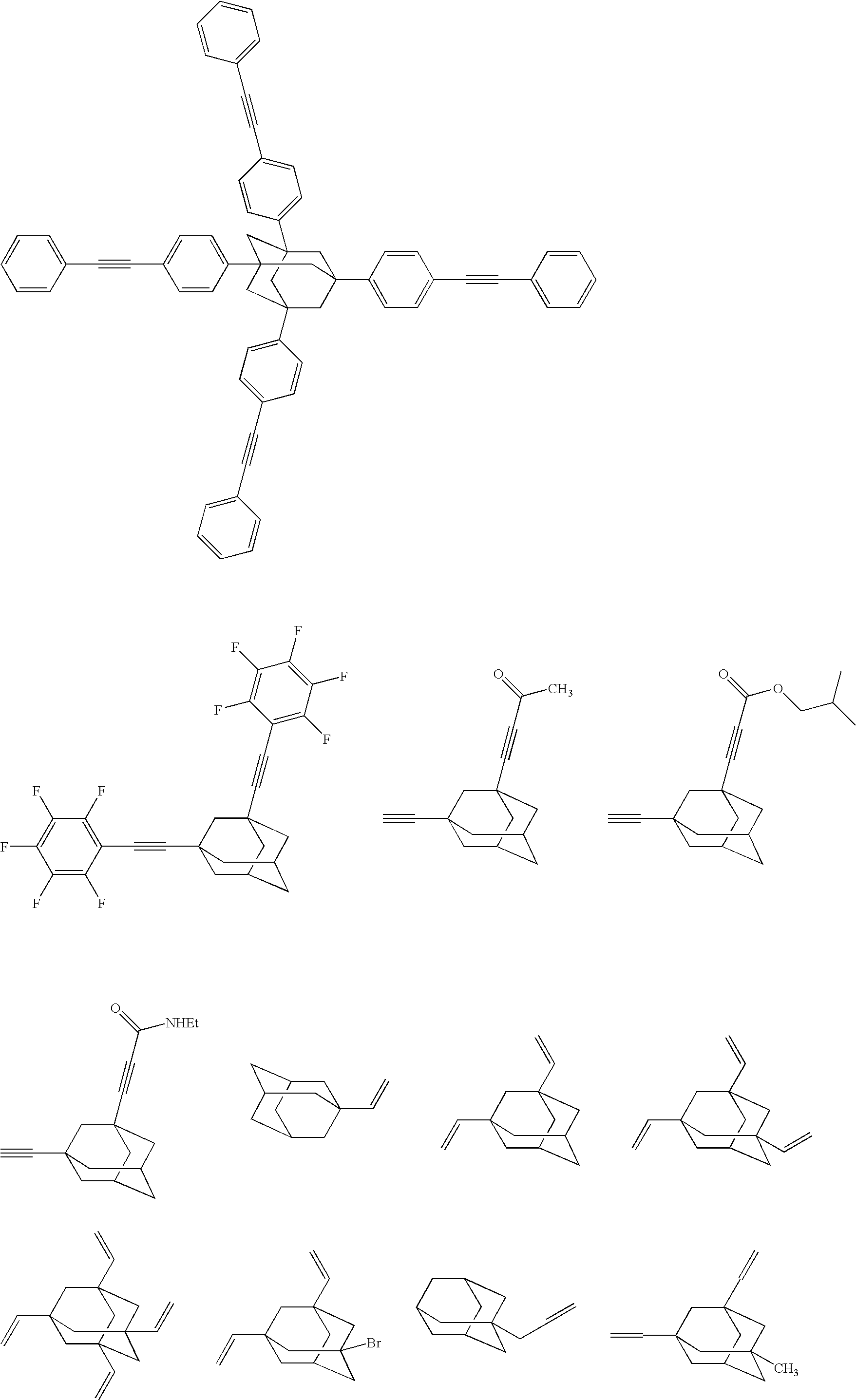

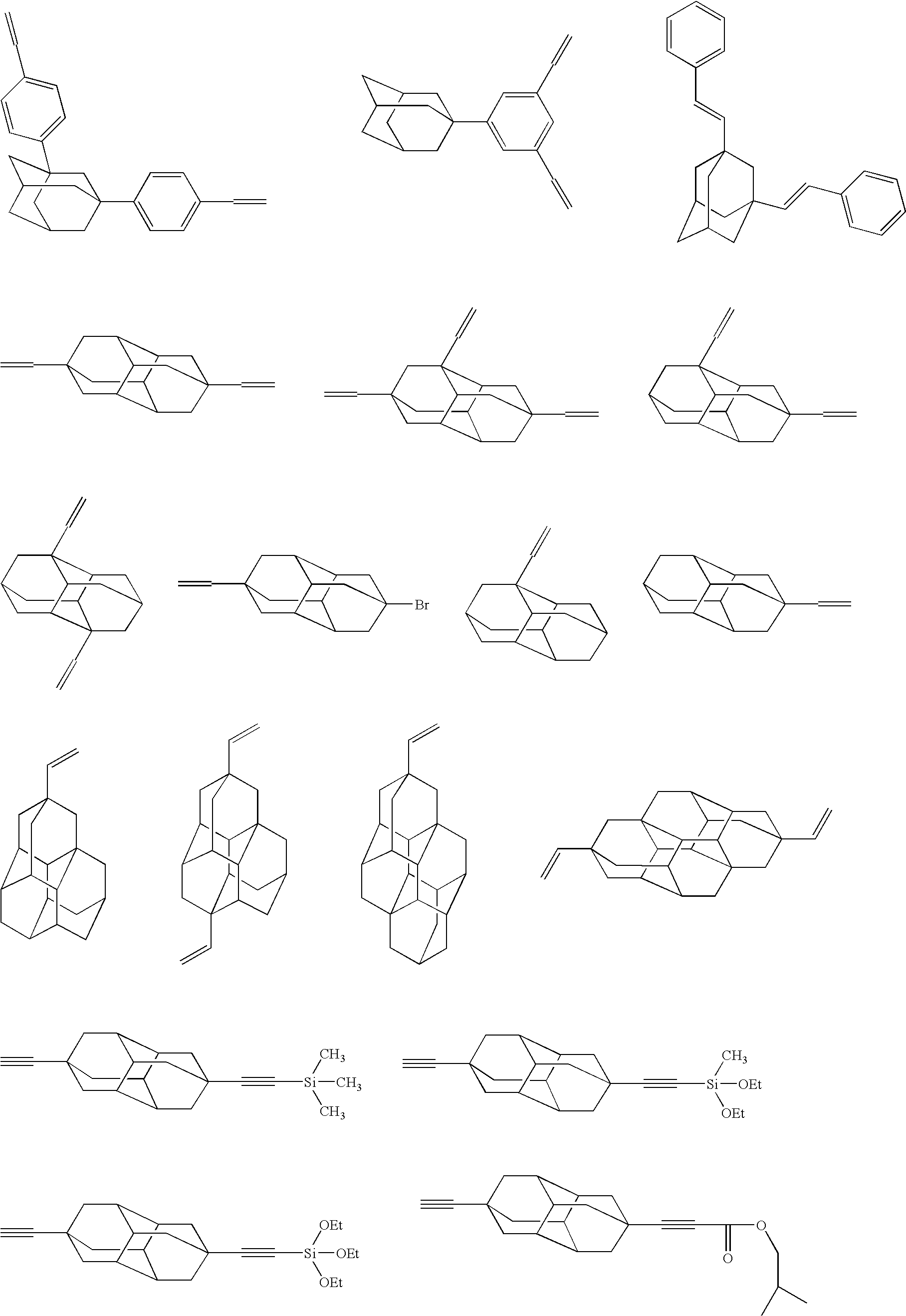

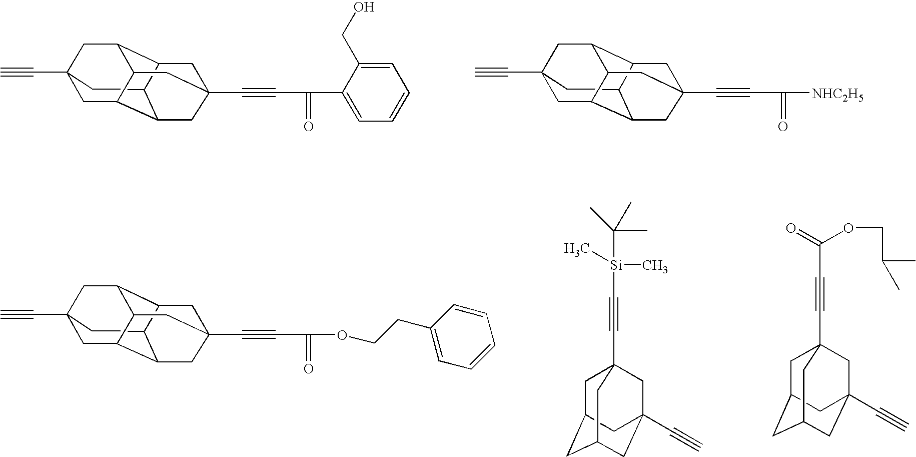

As the solvent to be used in the polymerization reaction, any solvent is usable insofar as it can dissolve a raw material monomer therein at a required concentration and has no adverse effect on the properties of a film formed from the polymer. Examples include water, alcohol solvents such as methanol, ethanol and propanol, ketone solvents such as alcohol acetone, methyl ethyl ketone, methyl isobutyl ketone, cyclohexanone and acetophenone; ester solvents such as ethyl acetate, butyl acetate, propylene glycol monomethyl ether acetate, γ-butyrolactone and methyl benzoate; ether solvents such as dibutyl ether and anisole; aromatic hydrocarbon solvents such as toluene, xylene, mesitylene, 1,2,4,5-tetramethylbenzene, pentamethylbenzene, isopropylbenzene, 1,4-diisopropylbenzene, t-butylbenzene, 1,4-di-t-butylbenzene, 1,3,5-triethylbenzene, 1,3,5-tri-t-butylbenzene, 4-t-butyl-orthoxylene, 1-methylnaphthalene and 1,3,5-triisopropylbenzene; amide solvents such as N-methylpyrrolidinone and dimethylacetamide; halogen solvents such as carbon tetrachloride, dichloromethane, chloroform, 1,2-dichloroethane, chlorobenzene, 1,2-dichlorobenzene and 1,2,4-trichlorobenzene; and aliphatic hydrocarbon solvents such as hexane, heptane, octane and cyclohexane. Of these solvents, preferred are acetone, methyl ethyl ketone, methyl isobutyl ketone, cyclohexanone, acetophenone, ethyl acetate, propylene glycol monomethyl ether acetate, γ-butyrolactone, anisole, tetrahydrofuran, toluene, xylene, mesitylene, 1,2,4,5-tetramethylbenzene, isopropylbenzene, t-butylbenzene, 1,4-di-t-butylbenzene, 1,3,5-tri-t-butylbenzene, 4-t-butyl-orthoxylene, 1-methylnaphthalene, 1,3,5-triisopropylbenzene, 1,2-dichloroethane, chlorobenzene, 1,2-dichlorobenzene and 1,2,4-trichlorobenzene, of which tetrahydrofuran, γ-butyrolactone, anisole, toluene, xylene, mesitylene, isopropylbenzene, t-butylbenzene, 1,3,5-tri-t-butylbenzene, 1-methylnaphthalene, 1,3,5-triisopropylbenzene, 1,2-dichloroethane, chlorobenzene, 1,2-dichlorobenzene, and 1,2,4-trichlorobenzene are more preferred and γ-butyrolactone, anisole, mesitylene, t-butylbenzene, 1,3,5-triisopropylbenzene, 1,2-dichlorobenzene and 1,2,4-trichlorobenzene are especially preferred. These solvents may be used either singly or as a mixture.

The monomer concentration in the reaction mixture is preferably from 1 to 50 mass %, more preferably from 5 to 30 mass %, especially preferably from 10 to 20 mass %.

The conditions most suited for the polymerization reaction in the invention differ, depending on the kind or concentration of the polymerization initiator, monomer or solvent. The polymerization reaction is performed preferably at a bulk temperature of from 0 to 200° C., more preferably from 50 to 170° C., especially preferably from 100 to 150° C., preferably for 1 to 50 hours, more preferably from 2 to 20 hours, especially preferably from 3 to 10 hours.

To suppress the inactivation of the polymerization initiator which will otherwise occur by oxygen, the reaction is performed preferably in an inert gas atmosphere (for example, nitrogen or argon). The oxygen concentration upon reaction is preferably 100 ppm or less, more preferably 50 ppm or less, especially preferably 20 ppm or less.

The monomer having the cage structure (a) according to the invention can be synthesized, for example, by using commercially available diamantane as a raw material, reacting it with bromine in the presence or absence of an aluminum bromide catalyst to introduce a bromine atom into a desired position, causing a Friedel-Crafts reaction between the resulting compound with vinyl bromide in the presence of a Lewis acid such as aluminum bromide, aluminum chloride or iron chloride to introduce a 2,2-dibromoethyl group, and then converting it into an ethynyl group by the HBr elimination using a strong base. More specifically, it can be synthesized in accordance with the process as described in Macromolecules, 24, 5266-5268 (1991) and 28, 5554-5560 (1995), Journal of Organic Chemistry, 39, 2995-3003 (1974) and the like.

An alkyl group or silyl group may be introduced by making the hydrogen atom of the terminal acetylene group anionic by butyl lithium or the like and then reacting the resulting compound with an alkyl halide or silyl halide.

As a preferred mode of the cage structure of the invention, on the other hand, the cage structure (b) formed by the leakage of each of m pieces of RSi(O_{0.5})₃ units (wherein m stands for an integer from 8 to 16 and Rs each independently represents a non-hydrolyzable group, with the proviso that at least two of the Rs each represents a vinyl- or ethynyl-containing group) to another RSi(O_{0.5})₃ unit via an oxygen atom possessed in common can be given.

In the above-described formula, Rs each independently represents a non-hydrolyzable group.

The term “non-hydrolyzable group” as used herein means a group, at least 95% of which remains when the group is brought into contact with 1 equivalent of neutral water for one hour at room temperature.

Of the Rs, at least two are each a vinyl- or ethynyl-containing group. Examples of the non-hydrolyzable group as R include alkyl groups (methyl, t-butyl, cyclopentyl, cyclohexyl and the like), aryl groups (phenyl, 1-naphthyl, 2-naphtyl and the like), vinyl group, ethynyl group, and allyl group.

At least two of the groups represented by R are each a vinyl- or ethynyl-containing group and it is preferred that at least two of them are each a vinyl-containing group. When a group represented by R contains a vinyl or ethynyl group, the vinyl or ethynyl group is preferably bonded, directly or via a divalent linking group, to a silicon atom to which R is bonded. Examples of the divalent linking group include —[C(R¹¹)(R¹²)]ₖ— (in which R¹¹ and R¹² each independently represents a hydrogen atom, methyl group or ethyl group and k stands for an integer from 1 to 6), —CO—, —O—, —N(R¹³)— (in which R¹³ represents a hydrogen atom, methyl group or ethyl group), —S—, and divalent linking groups obtained using the above-described groups in any combination. Of these, —[C(R¹¹)(R¹²)]ₖ—, —O—, and divalent linking groups obtained using these groups in any combination are preferred. In the cage structure (b), a vinyl or ethynyl group is preferably directly bonded to a silicon atom to which R is bonded.

It is more preferred that at least two vinyl groups of the Rs in the cage structure (b) are directly bonded to a silicon atom to which R is bonded. It is especially preferred that all the Rs represent a vinyl group.

The below-described structures represented by the below-described formulas (Q-1) to (Q-6) are preferred as the monomer having the cage structure (b).

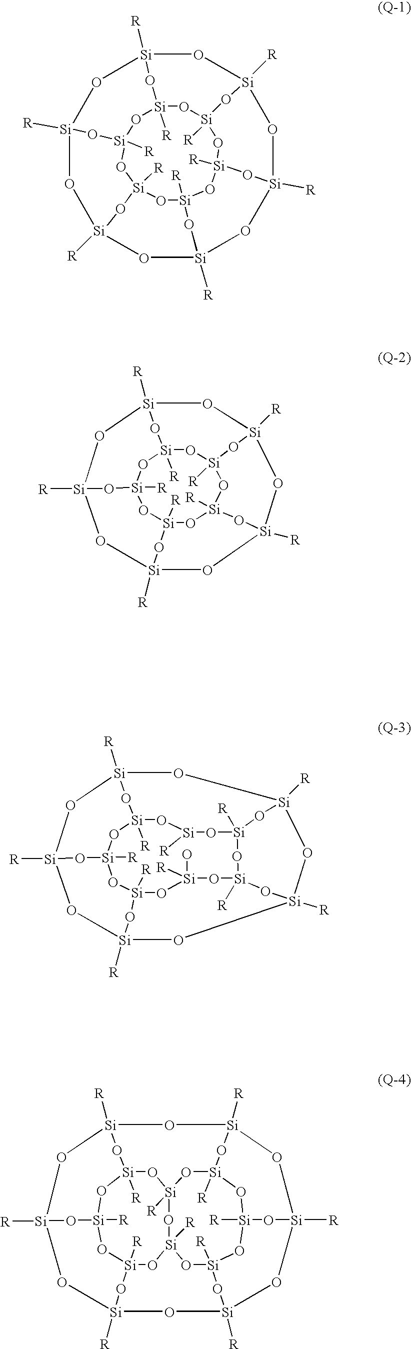

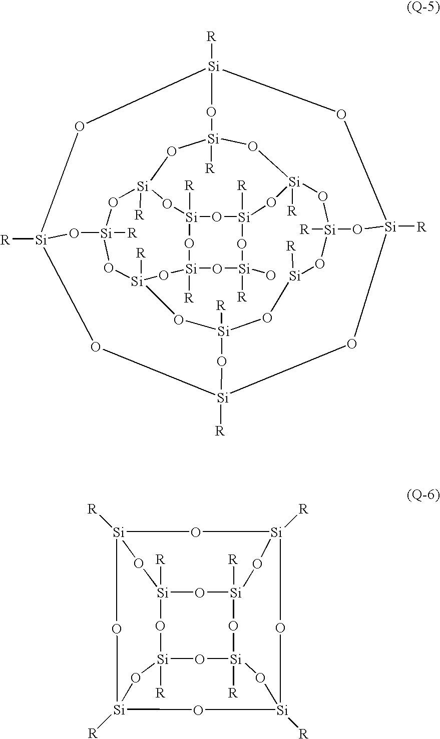

In the above-described formulas (Q-1) to (Q-6), R represents a non-hydrolyzable group.

Specific examples of R are similar to those described above.

Specific examples of the monomer having the cage structure (b) include, but not limited to, the following ones.

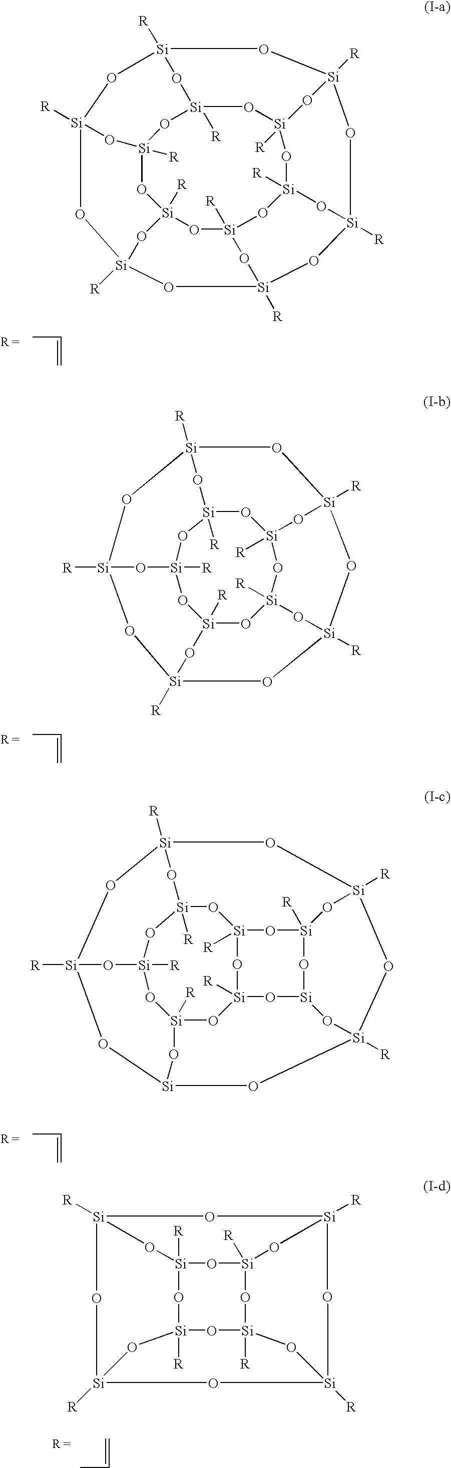

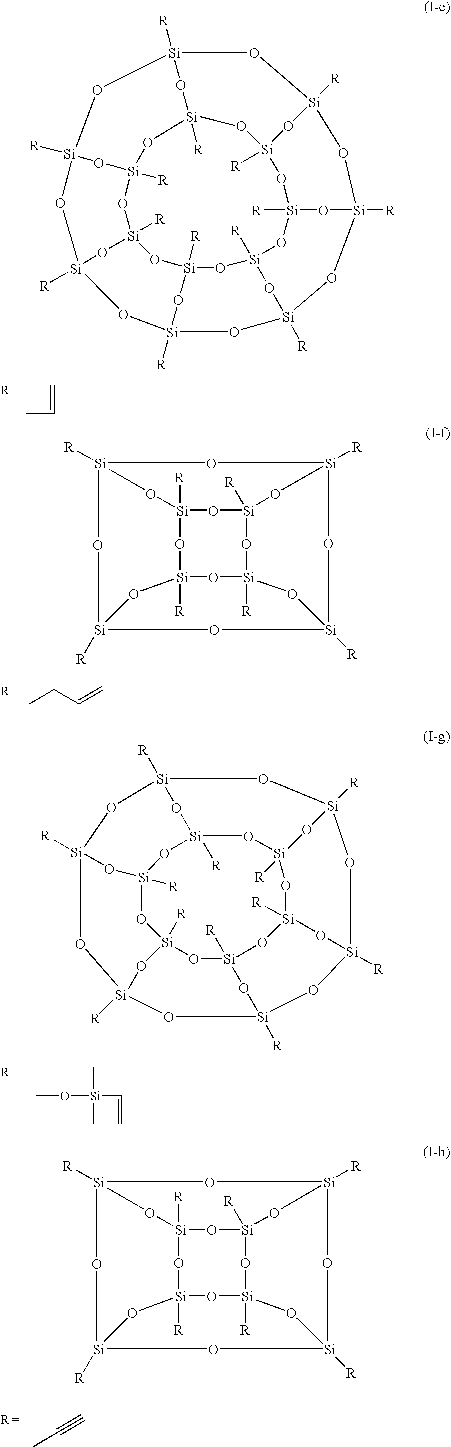

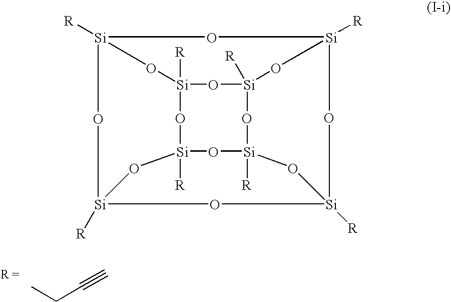

The monomer having the cage structure (b) may be a commercially available compound or may be synthesized in a known manner (J. Am. Chem. Soc., 111, 1741 (1989)).

In the composition of the present invention, the high polymer compound (A) having a repeating unit containing the cage structure (b) may contain a plurality of monomers different in kind. In this case, the composition may be a mixture of a plurality of copolymers different in the kind of the monomer having the cage structure (b) or a mixture of respective homopolymers of the monomer having the cage structure (b). When the composition of the invention contains a mixture of a plurality of copolymers different in the kind of the monomer having the cage structure (b), it is preferably a mixture of copolymers different in kind prepared using two or more monomers having the cage structure (b) selected from those having, as m, 8, 10 and 12, respectively.

As the polymer (A), a copolymer between a monomer having the cage structure (b) and another monomer is usable. As the another monomer used in such a case, compounds having a plurality of polymerizable carbon-carbon unsaturated bonds are preferred. Examples of the compounds include vinylsilanes, vinylsiloxanes, phenylacetylenes and the above-described monomers of the formulas (I) to (VI).

As a process for synthesizing the polymer (A) having a repeating unit containing the cage structure (b), it is preferred to dissolve the monomer in a solvent and then add a polymerization initiator to the resulting solution to cause reaction with a vinyl group or the like.

Although any polymerization reaction can be employed, examples include radical polymerization, cationic polymerization, anionic polymerization, ring-opening polymerization, polycondensation, polyaddition, addition condensation and polymerization in the presence of a transition metal catalyst.

The polymerization reaction of the monomer having the cage structure (b) is performed preferably in the presence of a non-metal polymerization initiator. For example, polymerization can be effected in the presence of a polymerization initiator that generates, by heating, a free radical such as carbon radical or oxygen radical and shows activity. Preferred examples of the polymerization initiator are similar to those exemplified above in the description of the polymerization reaction of the monomer having the cage structure (a).

The polymerization initiators may be used either singly or as a mixture for the polymerization reaction of the monomer having the cage structure (b).

The amount is preferably from 0.001 to 2 moles, more preferably from 0.001 to 1 mole, especially preferably from 0.05 to 0.5 mole, per mole of the monomer.

For the polymerization reaction of the monomer having the cage structure (b), any solvent is usable insofar as it can dissolve the monomer therein at a required concentration and does not adversely affect the properties of the film formed from the polymer thus obtained. Specific examples of the preferred solvent are similar to those exemplified above in the description of the polymerization reaction of the monomer having the cage structure (a).

The monomer concentration in the reaction mixture is preferably 30 mass % or less, more preferably 10 mass % or less, more preferably 5 mass % or less, still more preferably 1 mass % or less, most preferably 0.5 mass % or less. As the monomer concentration at the time of polymerization is lower, a composition having greater mass average molecular weight and number average molecular weight and soluble in the organic solvent can be synthesized.

The conditions most suited for the polymerization reaction of the monomer having the cage structure (b) differ, depending on the kind or concentration of the polymerization initiator, monomer or solvent. The polymerization reaction is performed preferably at a bulk temperature of from 0 to 200° C., more preferably from 40 to 170° C., especially preferably from 70 to 150° C., preferably for 1 to 50 hours, more preferably from 2 to 20 hours, especially preferably from 3 to 10 hours.

To suppress the inactivation of the polymerization initiator which will otherwise occur by oxygen, the reaction is performed preferably in an inert gas atmosphere (for example, nitrogen or argon). The oxygen concentration upon reaction is preferably 100 ppm or less, more preferably 50 ppm or less, especially preferably 20 ppm or less.

The mass average molecular weight (Mw) of the polymer available by the polymerization ranges preferably from 1000 to 1000000, more preferably from 2000 to 500000, especially preferably from 3000 to 100000.

The polymer (A) having a repeating unit containing the cage structure (b) is preferably soluble in an organic solvent. The term “soluble in an organic solvent” as used herein is defined as that 5 mass % or greater of the compound dissolves at 25° C. in a solvent selected from cyclohexanone, methyl ethyl ketone, methyl isobutyl ketone, propylene glycol monomethyl ether acetate, propylene glycol monomethyl ether and γ-butyrolactone. The amount of the compound which dissolves in the above-described solvent is preferably 10 mass % or greater, more preferably 20 mass % or greater.

The degree of dispersion (Mw/Mn) of the polymer (A) having a repeating unit containing the cage structure (b) as calculated from GPC chart is preferably from 1 to 15, more preferably from 1 to 10, most preferably from 1 to 5. When the Mw is equal, as the degree of the dispersion is smaller, a film having a lower density, lower refractive index and lower dielectric constant can be formed.

The composition having the above-described physical properties can be produced by polymerizing the monomer having the cage structure (b), while using high dilution conditions, adding a chain transfer agent, optimizing a reaction solvent, continuously adding the polymerization initiator, continuously adding the monomer, adding a radical trapping agent, or the like.

It is also possible to filter off insoluble matters, purify by column chromatography, purify by re-precipitation treatment or the like after polymerization of the monomer having the cage structure (b).

The term “re-precipitation treatment” as used herein means collection of the composition of the invention by filtration after it is precipitated by adding a poor solvent (a solvent which does not substantially dissolve the composition of the invention therein) to the reaction mixture from which the reaction solvent has been distilled off as needed or adding dropwise the reaction mixture from which the reaction solvent has been distilled off as needed to a poor solvent.

The poor solvent is preferably an alcohol (such as methanol, ethanol, or isopropyl alcohol). The poor solvent is added in an amount of from equal mass to 200 times the mass, more preferably from 2 to 50 times the mass of the composition of the invention.

When the polymer (A) having a repeating unit containing a cage structure (b) is used, it is preferred to distill off the solvent used for the polymerization reaction and thereby use the polymer in the concentrated form. In addition, the polymer is preferably used after re-precipitation treatment. The polymer is concentrated preferably by heating and/or reducing the pressure of the reaction mixture in a rotary evaporator, distiller or a reaction apparatus used for the polymerization reaction. The temperature of the reaction mixture at the time of concentration is usually from 0 to 180° C., preferably from 10 to 140° C., more preferably from 20 to 100° C., most preferably from 30 to 60° C. The pressure at the time of concentration is usually from 0.001 to 760 torr, preferably from 0.01 to 100 torr, more preferably from 0.01 to 10 torr. When the reaction mixture is concentrated, it is concentrated until the solid content in the reaction mixture reaches preferably 10 mass % or greater, more preferably 30 mass % or greater, most preferably 50 mass % or greater.

For the insulating film forming composition of the invention, the polymers (A) as described above may be used either singly or as a mixture.

### Coating Solvent (B)

Although a coating solvent (B) to be used for the insulating film forming composition of the invention is not particularly limited, examples of it include alcohol solvents such as methanol, ethanol, 2-propanol, 1-butanol, 2-ethoxymethanol, 3-methoxypropanol and 1-methoxy-2-propanol; ketone solvents such as acetone, acetyl acetone, methyl ethyl ketone, methyl isobutyl ketone, 2-pentanone, 3-pentanone, 2-heptanone, 3-heptanone, cyclopentanone, and cyclohexanone; ester solvents such as ethyl acetate, propyl acetate, butyl acetate, isobutyl acetate, pentyl acetate, ethyl propionate, propyl propionate, butyl propionate, isobutyl propionate, propylene glycol monomethyl ether acetate, methyl lactate, ethyl lactate, and γ-butyrolactone; ether solvents such as diisopropyl ether, dibutyl ether, ethyl propyl ether, anisole, phenetole and veratrole; aromatic hydrocarbon solvents such as mesitylene, ethylbenzene, diethylbenzene, propylbenzene and t-butylbenzene; and amide solvents such as N-methylpyrrolidinone and dimethylacetamide. These solvents may be used either singly or in combination.

Of these, 1-methoxy-2-propanol, propanol, acetylacetone, cyclohexanone, propylene glycol monomethyl ether acetate, butyl lactate, methyl lactate, ethyl lactate, γ-butyrolactone, anisole, mesitylene, and t-butylbenzene are more preferred, with 1-methoxy-2-propanol, cyclohexanone, propylene glycol monomethyl ether acetate, ethyl lactate, γ-butyrolactone, t-butylbenzene and anisole being especially preferred.

### Surfactant (C)

To the insulating film forming composition of the invention, a surfactant (C) can be added as needed to regulate the uniformity of the film thickness of the coat. Examples of the surfactant (C) which can be added include nonionic surfactants, anionic surfactants, and cationic surfactants. Additional examples include silicone surfactants, fluorine-containing surfactants, polyalkylene-oxide surfactants, and acrylic surfactants. In the invention, these surfactants may be used either singly or in combination. Of these, silicone surfactants, nonionic surfactants, fluorine-containing surfactants and acrylic surfactants are preferred, with silicone surfactants being especially preferred.

In the invention, the amount of the surfactant to be added is preferably 0.01 mass % or greater but not greater than 1 mass %, more preferably 0.1 mass % or greater but not greater than 0.5 mass %, based on the total amount of the coating solution.

The term “silicone surfactant” as used herein means a surfactant containing at least one Si atom. Any silicon surfactant is usable in the invention and a silicone surfactant having a structure containing an alkylene oxide and dimethylsiloxane is preferred, with a silicone surfactant having a structure containing the below-described formula being more preferred.

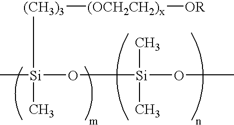

In the above formula, R represents a hydrogen atom or a C₁₋₅ alkyl group, x stands for an integer from 1 to 20, m and n each independently represents an integer from 2 to 100. A plurality of Rs may be the same or different.

Examples of the silicone surfactant to be used in the invention include “BYK306” and “BYK307” (each, trade name; product of BYK CHEMIE), “SH7PA”, “SH21PA”, “SH28PA”, and “SH30PA” (each, trade name; product of Dow Corning Toray Silicone), and “Troysol S366” (trade name; product of Troy Chemical).

As the nonionic surfactant, any nonionic surfactant is usable in the invention. Examples include polyoxyethylene alkyl ethers, polyoxyethylene aryl ethers, polyoxyethylene dialkyl esters, sorbitan fatty acid esters, fatty acid-modified polyoxyethylenes, and polyoxyethylene-polyoxypropylene block copolymers.

In the invention, any fluorine-containing surfactant is usable. Examples of include perfluorooctylpolyethylene oxide, perfluorodecylpolyethylene oxide and perfluorododecylpolyethylene oxide.

As the acrylic surfactant, any acrylic surfactant is usable in the invention. Examples include (meth)acrylic acid copolymers.

### Other Physical Property Regulators (D) of the Insulating Film

To the insulating film forming composition of the invention, additives such as radical generator, colloidal silica, silane coupling agent, adhesion accelerator, and pore forming agent may be added in an amount so as not to impair the physical properties (such as heat resistance, dielectric constant, mechanical strength, coatability and adhesion) of the resulting insulating film.

Any colloidal silica may be used in the invention. For example, a dispersion obtained by dispersing high purity silicic anhydride in a hydrophilic solvent or water can be used. It usually has an average particle size of from 5 to 30 nm, preferably from 10 to 20 nm and has a solid concentration of from about 5 to 40 mass %.

Any silane coupling agent may be used in the invention. Examples include 3-glycidyloxypropyltrimethoxysilane, 3-aminoglycidyloxypropyltriethoxysilane, 3-methacryloxypropyltrimethoxysilane, 3-glycidyloxypropylmethyldimethoxysilane, 1-methacryloxypropylmethyldimethoxysilane, 3-aminopropyltrimethoxysilane, 3-aminopropyltriethoxysilane, 2-aminopropyltrimethoxysilane, 2-aminopropyltriethoxysilane, N-(2-amino ethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-triethoxysilylpropyltriethylenetriamine, 10-trimethoxysilyl-1,4,7-triazadecane, 10-triethoxysilyl-1,4,7-triazadecane, 9-trimethoxysilyl-3,6-diazanonyl acetate, 9-triethoxysilyl-3,6-diazanonyl acetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, and N-bis(oxyethylene)-3-aminopropyltriethoxysilane. Those silane coupling agents may be used either singly or in combination. The silane coupling agent may be added preferably in an amount of 10 parts by weight or less, especially preferably from 0.05 to 5 parts by weight based on 100 parts by weight of the whole solid content.

In the invention, any adhesion accelerator may be used. Examples include trimethoxysilylbenzoic acid, γ-methacryloxypropyltrimethoxysilane, vinyltriacetoxysilane, vinyltrimethoxysilane, γ-isocyanatopropyltriethoxysilane, γ-glycidoxypropyltrimethoxysilane, β-(3,4-epoxycyclohexyl)ethyltrimethoxysilane, trimethoxyvinylsilane, γ-aminopropyltriethoxysilane, aluminum monoethylacetoacetate disopropylate, vinyltris(2-methoxyethoxy)silane, N-(2-aminoethyl)-3-aminopropylmethyldimethoxysilane, N-(2-amino ethyl)-3-aminopropyltrimethoxysilane, 3-chloropropylmethyldimethoxysilane, 3-chloropropyltrimethoxysilane, 3-methacryloxypropyltrimethoxysilane, 3-mercaptopropyltrimethoxysilane, trimethylchlorosilane, dimethylvinylchlorosilane, methyldiphenylchlorosilane, chloromethyldimethylchlorosilane, trimethylmethoxysilane, dimethyldiethoxysilane, methyldimethoxysilane, dimethylvinylethoxysilane, diphenyldimethoxysilane, phenyltriethoxysilane, hexamethyldisilazane, N,N′-bis(trimethylsilyl)urea, dimethyltrimethylsilylamine, trimethylsilylimidazole, vinyltrichlorosilane, benzotriazole, benzimidazole, indazole, imidazole, 2-mercaptobenzimidazole, 2-mercaptobenzothiazole, 2-mercaptobenzoxazole, urazole, thiourasil, mercaptoimidazole, mercaptopyrimidine, 1,1-dimethylurea, 1,3-dimethylurea and thiourea compounds. A functional silane coupling agent is preferred as an adhesion accelerator. The amount of the adhesion accelerator is preferably 10 parts by weight or less, especially preferably from 0.05 to 5 parts by weight, based on 100 parts by weight of the total solid content.

It is also possible to form a porous film by adding a pore forming factor to the extent allowed by the mechanical strength of the film and thereby reducing the dielectric constant of the film.

Although no particular limitation is imposed on the pore forming factor as an additive that will be a pore forming agent, a non-metallic compound is preferred. The pore forming agent must satisfy both the solubility in a solvent to be used for a coating solution and compatibility with the polymer of the invention. The boiling point or decomposition point of the pore forming agent is preferably from 100 to 500° C., more preferably from 200 to 450° C., especially preferably from 250 to 400° C. The molecular weight of it is preferably from 200 to 50000, more preferably from 300 to 10000, especially preferably from 400 to 5000. The amount of it in terms of mass % is preferably from 0.5 to 75%, more preferably from 0.5 to 30%, especially preferably from 1 to 20% of the polymer for forming a film. The polymer may contain a decomposable group as the pore forming factor. The decomposition point of it is preferably from 100 to 500° C., more preferably from 200 to 450° C., especially preferably from 250 to 400° C. The content of the decomposable group is, in terms of mole %, from 0.5 to 75%, more preferably from 0.5 to 30%, especially preferably from 1 to 20% of the polymer for forming the film.

The total solid concentration in the insulating film forming composition of the invention is preferably from 0.1 to 50 mass %, more preferably from 0.5 to 15 mass %, especially preferably from 1 to 10 mass %.

The content of metals, as an impurity, of the film forming composition of the invention is preferably as small as possible. The metal content of the film forming composition can be measured with high sensitivity by the ICP-MS and in this case, the content of metals other than transition metals is preferably 30 ppm or less, more preferably 3 ppm or less, especially preferably 300 ppb or less. The content of the transition metal is preferably as small as possible because it accelerates oxidation by its high catalytic capacity and the oxidation reaction in the prebaking or thermosetting process decreases the dielectric constant of the film obtained by the invention. The metal content is preferably 10 ppm or less, more preferably 1 ppm or less, especially preferably 100 ppb or less.

The metal concentration of the film forming composition can also be evaluated by subjecting a film obtained using the film forming composition of the invention to total reflection fluorescent X-ray analysis. When W ray is employed as an X-ray source, the metal concentrations of metal elements such as K, Ca, Ti, Cr, Mn, Fe, Co, Ni, Cu, Zn, and Pd can be measured. The concentrations of them are each preferably from 100×10¹⁰ atom·cm⁻² or less, more preferably 50×10¹⁰ atom·cm⁻² or less, especially preferably 10×10¹⁰ atom·cm⁻² or less. In addition, the concentration of Br as a halogen can be measured. Its remaining amount is preferably 10000×10¹⁰ atom·cm⁻² or less, more preferably 1000×10¹⁰ atom·cm⁻², especially preferably 400×10¹⁰ atom cm⁻². Moreover, the concentration of Cl can also be observed as a halogen. In order to prevent it from damaging a CVD device, etching device or the like, its remaining amount is preferably 100×10¹⁰ atom·cm⁻² or less, more preferably 50×10¹⁰ atom·cm⁻², especially preferably 10×10¹⁰ atom·cm⁻².

In the invention, the above-described components may be filtered through a filter made of polyethylene or nylon and then mixed, but it is preferred to mix all the components and then, filter the resulting mixture through a filter made of polyethylene or nylon.

When the components are filtered respectively, the organic polymer and polymer (A) containing a cage structure are preferably filtered.

An insulating film is formed using the filtrate thus obtained.

The film can be formed by applying the film forming composition of the invention onto a substrate by a desired method such as spin coating, roller coating, dip coating or scan coating, and then heating the substrate to remove the solvent. For drying off the solvent, the substrate is heated preferably for 0.1 to 10 minutes at from 40 to 250° C.

As the method of applying the composition to the substrate, spin coating and scan coating are preferred, with spin coating being especially preferred. For spin coating, commercially available apparatuses such as “Clean Track Series” (trade name; product of Tokyo Electron), “D-spin Series” (trade name; product of Dainippon Screen), or “SS series” or “CS series” (each, trade name; product of Tokyo Oka Kogyo) are preferably employed. The spin coating may be performed at any rotation speed, but from the viewpoint of in-plane uniformity of the film, a rotation speed of about 1300 rpm is preferred for a 300-mm silicon substrate.

When the solution of the composition is discharged, either dynamic discharge in which the solution is discharged onto a rotating substrate or static discharge in which the solution is discharged onto a static substrate may be employed. The dynamic discharge is however preferred in view of the in-plane uniformity of the film. Alternatively, from the viewpoint of reducing the consumption amount of the composition, a method of discharging only a main solvent of the composition to a substrate in advance to form a liquid film and then discharging the composition thereon can be employed. Although no particular limitation is imposed on the spin coating time, it is preferably within 180 seconds from the viewpoint of throughput. From the viewpoint of the transport of the substrate, it is preferred to subject the substrate to processing (such as edge rinse or back rinse) for preventing the film from remaining at the edge portion of the substrate. The heat treatment method is not particularly limited, but ordinarily employed methods such as hot plate heating, heating with a furnace, heating in an RTP (Rapid Thermal Processor) to expose the substrate to light of, for example, a xenon lamp can be employed. Of these, hot plate heating or heating with a furnace is preferred. As the hot plate, a commercially available one, for example, “Clean Track Series” (trade name; product of Tokyo Electron), “D-spin Series” (trade name; product of Dainippon Screen) and “SS series” or “CS series” (trade name; product of Tokyo Oka Kogyo) is preferred, while as the furnace, “a series” (trade name; product of Tokyo Electron) is preferred.

It is especially preferred to apply the polymer of the invention onto a substrate and then heating to cure it. For this purpose, the polymerization reaction, at the time of post heating, of a carbon-carbon double bond or a carbon-carbon triple bond remaining in the polymer may be utilized. The post heat treatment is performed preferably at from 100 to 450° C., more preferably at from 200 to 420° C., especially preferably at from 350 to 400° C., preferably for from 1 minute to 2 hours, more preferably for from 10 minutes to 1.5 hours, especially preferably for from 30 minutes to 1 hour. The post heat treatment may be performed in several times. This post heat treatment is performed especially preferably in a nitrogen atmosphere in order to prevent thermal oxidation due to oxygen.

In the invention, the polymer may be cured not by heat treatment but by exposure to high energy radiation to cause polymerization reaction of a carbon-carbon double bond or carbon-carbon triple bond remaining in the polymer. Examples of the high energy radiation include electron beam, ultraviolet ray and X ray. The curing method is not particularly limited to these methods.

When electron beam is employed as high energy radiation, the energy is preferably from 0 to 50 keV, more preferably from 0 to 30 keV, especially preferably from 0 to 20 keV Total dose of electron beam is preferably from 0 to 5 μC/cm² or less, more preferably from 0 to 2 μC/cm², especially preferably from 0 to 1 μC/cm² or less. The substrate temperature when it is exposed to electron beam is preferably from 0 to 450° C., more preferably from 0 to 400° C., especially preferably from 0 to 350° C. Pressure is preferably from 0 to 133 kPa, more preferably from 0 to 60 kPa, especially preferably from 0 to 20 kPa. The atmosphere around the substrate is preferably an atmosphere of an inert gas such as Ar, He or nitrogen from the viewpoint of preventing oxidation of the polymer of the invention. An oxygen, hydrocarbon or ammonia gas may be added for the purpose of causing reaction with plasma, electromagnetic wave or chemical species which is generated by the interaction with electron beam. In the invention, exposure to electron beam may be carried out in plural times. In this case, the exposure to electron beam is not necessarily carried out under the same conditions but the conditions may be changed every time.

Ultraviolet ray may be employed as high energy radiation. The radiation wavelength range of the ultraviolet ray is preferably from 190 to 400 nm, while its output immediately above the substrate is preferably from 0.1 to 2000 mWcm⁻². The substrate temperature upon exposure to ultraviolet ray is preferably from 250 to 450° C., more preferably from 250 to 400° C., especially preferably from 250 to 350° C. The atmosphere around the substrate is preferably an atmosphere of an inert gas such as Ar, He or nitrogen from the viewpoint of preventing oxidation of the polymer of the invention. The pressure at this time is preferably from 0 to 133 kPa.

When the film obtained using the film forming composition of the invention is used as an interlayer insulating film for semiconductor, a barrier layer for preventing metal migration may be disposed on the side of an interconnect. In addition, a cap layer, an interlayer adhesion layer or etching stopping layer may be disposed on the upper or bottom surface of the interconnect or interlayer insulating film to prevent exfoliation at the time of CMP (Chemical Mechanical Polishing). Moreover, the layer of an interlayer insulating film may be composed of plural layers using another material as needed.

The film obtained using the film forming composition of the invention can be etched for copper interconnection or another purpose. Either wet etching or dry etching can be employed, but dry etching is preferred. For dry etching, either ammonia plasma or fluorocarbon plasma can be used as needed. For the plasma, not only Ar but also a gas such as oxygen, nitrogen, hydrogen or helium can be used. Etching may be followed by ashing for the purpose of removing a photoresist or the like used for etching. Moreover, the ashing residue may be removed by washing.

The film obtained using the film forming composition of the invention may be subjected to CMP for planarizing the copper plated portion after copper interconnection. As a CMP slurry (chemical solution), a commercially available one (for example, product of Fujimi Incorporated, Rodel Nitta, JSR or Hitachi Chemical) can be used as needed. As a CMP apparatus, a commercially available one (for example, product of Applied Material or Ebara Corporation) can be used as needed. After CMP, the film can be washed in order to remove the slurry residue.

The film available using the insulating film forming composition of the invention can be used for various purposes. For example, it is suited for use as an insulating film in semiconductor devices such as LSI, system LSI, DRAM, SDRAM, RDRAM and D-RDRAM, and in electronic devices such as multi-chip module multi-layered wiring board. It can also be used as a passivation film or an α-ray shielding film for LSI, a coverlay film for flexographic printing plate, an overcoat film, a cover coating for a flexible copper-clad board, a solder resist film, and a liquid crystal alignment film as well as an interlayer insulating film for semiconductor, an etching stopper film, a surface protective film, and a buffer coating film.

For another purpose, the film of the invention doped with an electron donor or acceptor to make it conductive can be used as a conductive film.

### EXAMPLES 1

The invention will hereinafter be described further by Examples and Comparative Examples. It should however be borne in mind that the present invention is not limited to or by them.

### EXAMPLES 1 TO 40 AND COMPARATIVE EXAMPLES 1 AND 2 SYNTHESIS EXAMPLE 1

In accordance with the synthesis process as described in Macromolecules, 5266 (1991), 4,9-diethynyldiamantane (a) was synthesized. Under a nitrogen gas stream, 2 g of the resulting 4,9-diethynyldiamantane (a), 0.22 g of dicumyl peroxide (“PERCUMYL D”, trade name; product of NOF) and 10 ml of t-butylbenzene were polymerized by stirring for 7 hours at a bulk temperature of 150° C. After the reaction mixture was cooled to room temperature, 60 ml of isopropyl alcohol was added. The solid thus precipitated was collected by filtration and rinsed with isopropyl alcohol sufficiently, whereby a desired polymer of 4,9-diethynyldiamantane (a) was obtained.

In a similar manner to Synthesis Example 1 except for the use of 3,3,3′,3′-triethynyl-1′,1′-biadamantane (b), 3,3′-diethynyl-1,1′-biadamantane (c), 1,6-diethynyldiamantane (d), 1,4,6,9-tetraethynyldiamantane (e), Example Compound (I-a), and Example Compound (1-d) in stead of 4,9-diethynyldiamantane (a), polymers were obtained, respectively. As the Example compound (I-a), a cage-like silsesquioxane composed of 12H₂C═CH—Si(O_{0.5})₃ units obtained purifying a mixture of a cage-like silsesquioxane composed of 8H₂C═CH—Si(O_{0.5})₃ units, a cage-like silsesquioxane composed of 10H₂C═CH—Si(O_{0.5})₃ units, and a cage-like silsesquioxane composed of 12H₂C═CH—Si(O_{0.5})₃ units (Model number: OL1170, product of Hybrid Plastics) was used, while a product of Aldrich was used as Example compound (1-d).

### SYNTHESIS EXAMPLE 2

In 4 L of γ-butyrolactone were dissolved 3,3′-(oxydi-1,4-phenylene)bis(2,4,5-triphenylcyclopentadienone) (Compound (f), 782.4 g, 1.0 mole) and 1,3,5-tris(phenylethynyl)benzene (Compound (g), 378.2 g, 1.00 mole) and the resulting solution was charged in a flask. After the flask was purged with nitrogen, the resulting solution was stirred while heating to 200° C. After heating for 12 hours, the solution was cooled to room temperature and added to 5 L of ethanol. A powdery solid thus precipitated was a polymer as a Diels-Alder reaction product of Compound (f) and Compound (g). As Compound (f) and Compound (g), those synthesized in accordance with the process of Example 1 of JP-A-2001-106880 were employed.

<Preparation of a Coat Forming Composition>

A raw coating solution was prepared by completely dissolving each of the polymers obtained in the above synthesis examples in cyclohexanone to give a solid content of 3.0 mass %. The resulting raw coating solution was filtered through a filter as shown below in Table 1 to prepare a coating solution. Coating solutions other than those of Examples 1 and 3 and Comparative Examples 1 and 2 were each subjected to pre-filtration through a polyethylene filter having a pore size of 0.1 μm prior to filtering through the filter shown in Table 1.

<Measurement of Specific Dielectric Constant and Insulation Properties>

The coating solution thus prepared was spin coated onto an 8-inch bare silicon wafer having a substrate resistance of 7 Ω/cm by using a spin coater “ACT-8SOD” (trade name; product of Tokyo Electron). The coat was baked at 110° C. for 60 seconds and then at 200° C. for 60 seconds, followed by baking for 1 hour in a clean oven purged with nitrogen and set at 40° C., whereby a film of 100 nm thick was obtained. The specific dielectric constant of the film thus obtained was calculated from an electric capacitance at 1 MHz by using a mercury probe (product of Four Dimensions) and an LCR meter “HP4285A” (trade name; product of Yokogawa Hewlett Packard).

A voltage was applied gradually to the resulting film by using a mercury probe (product of Four Dimensions) and an LCR meter “HP4285A” (trade name; product of Yokogawa Hewlett Packard) and leak current at the time when the field intensity in the insulating film was 1.0 MV/cm was measured. When an applied voltage was raised to a certain level, the leak current exceeded 1E-3 A/cm² (1×10⁻³ A/cm²). The voltage applied to the insulating film at this time was measured as a breakdown voltage. The leak current and breakdown voltage were each measured at 20 points on the 8-inch wafer and an average was calculated.

Evaluation results are shown in Table 1 collectively.

TABLE 1

| | | | Molec- | | | | Leak | |
|---|---|---|---|---|---|---|---|---|
| | | | ular | | | | current | Break- |
| | | | weight | Filter | | Specific | (A/cm², | down |
| | | | of | | Pore | di- | at | voltage |
| | | Raw monomer of | polymer | | size | electric | 1.0 | (MV/ |
| | | polymer (A) | (A) | Material | (μm) | constant | MV/cm) | cm) |
| Ex. | 1 2 3 4 5 6 7 8 9101112 | 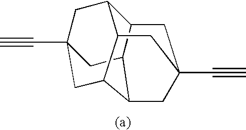 | 21200 35000 76000 | Nylon-66 PE Nylon-66PE Nylon-66PE | 0.040.020.050.030.020.010.020.020.010.020.020.01 | 2.432.432.412.432.442.412.432.442.432.412.442.41 | 6.9E−115.0E−111.5E−109.8E−117.0E−117.8E−115.0E−115.8E−115.6E−116.1E−116.3E−116.2E−11 | 6.06.56.06.16.36.36.86.56.47.06.36.4 |
| | 131415 | 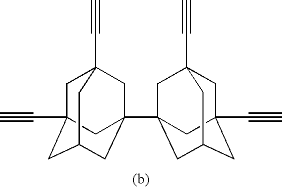 | 26200 | PE Nylon-66 | 0.020.010.02 | 2.432.442.39 | 4.5E−106.8E−116.8E−11 | 6.46.76.9 |
| | 161718 | 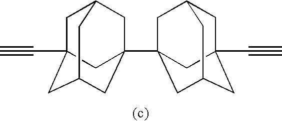 | 12300 | PE Nylon-66 | 0.050.010.02 | 2.412.402.38 | 4.1E−107.7E−115.0E−11 | 6.76.87.5 |
| | 192021 | 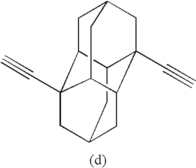 | 15600 | PE Nylon-66 | 0.020.010.02 | 2.442.402.38 | 5.0E−115.8E−114.0E−11 | 6.06.06.9 |
| | 22232425 | 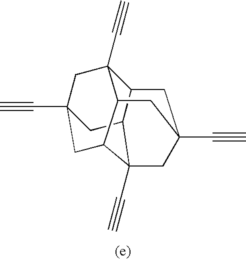 | 21100 | PE Nylon-66 | 0.050.020.010.02 | 2.352.352.362.31 | 4.0E−115.8E−114.0E−114.5E−11 | 7.06.86.97.5 |
| | 2627282930 | 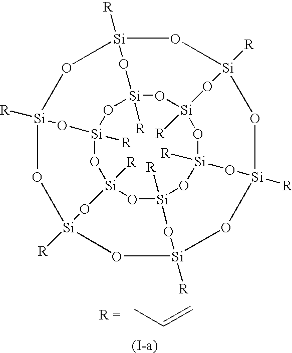 | 89600 | PE Nylon-66 | 0.050.020.010.040.02 | 2.352.382.362.352.34 | 4.0E−104.5E−108.7E−118.9E−117.0E−11 | 6.16.06.87.07.1 |
| | 3132333435 | 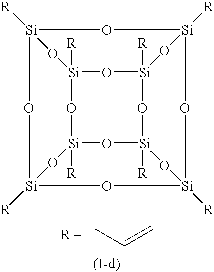 | 96870 | PE Nylon-66 | 0.050.020.010.040.02 | 2.392.382.382.342.35 | 8.9E−107.0E−109.8E−117.0E−117.0E−11 | 6.56.56.47.06.9 |
| | 3637383940 | 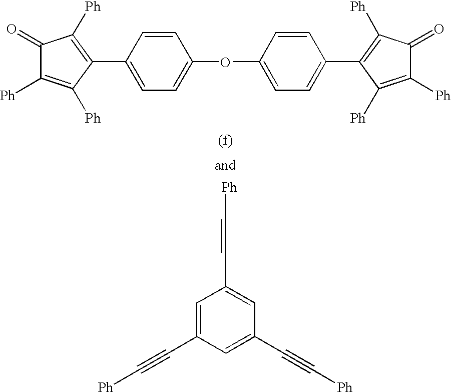 | 38000 | PE Nylon-66 | 0.050.020.010.040.02 | 2.752.762.712.692.70 | 8.9E−101.2E−101.1E−108.8E−118.7E−11 | 6.06.46.56.16.8 |
| Comp.Ex. | 1 2 | 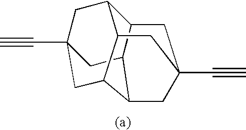 | 21200 | NonePTFE | 0.05 | 2.452.44 | 5.5E−064.5E−08 | 1.83.0 |

As shown in Table 1, it has been understood that the production process of the invention comprising at least a step of filtering through a filter made of polyethylene or nylon makes it possible to prepare a composition for forming an insulating film which is excellent in insulation properties such as leak current and breakdown voltage without impairing the dielectric constant properties of the film.

According to the present invention, a production process of a composition for forming an insulating film excellent in insulation properties such as leak current and breakdown voltage and good in film properties such as mechanical strength and heat resistance without impairing a low dielectric constant of the film is provided. According to the present invention, a composition for forming an insulating film good in the above-described insulation properties and film properties, which composition is produced by the above-described production process; an insulating film available by using the composition; and an electronic device having the insulating film are also provided.

The entire disclosure of each and every foreign patent application from which the benefit of foreign priority has been claimed in the present application is incorporated herein by reference, as if fully set forth.

What is claimed is:

1. A production method of an insulating film forming composition, comprising:
a process of filtering the composition through a filter made of polyethylene or nylon.

2. The production method according to claim 1,
wherein the filter is made of nylon 66.

3. The production method according to claim 1,
wherein the composition to be filtered comprises an organic polymer.

4. The production method according to claim 1,
wherein the composition to be filtered comprises (A) at least one kind of polymer comprising a repeating unit having a cage structure.

5. The production method according to claim 4,
wherein each of the at least one kind of polymer (A) is derived from a monomer having a cage structure having a polymerizable carbon-carbon double bond or carbon-carbon triple bond.

6. The production method according to claim 4,
wherein the cage structure is selected from the group consisting of adamantane, biadamantane, diamantane, triamantane, tetramantane and dodecahedrane.

7. The production method according to claim 5,
wherein the monomer having a cage structure is selected from the group consisting of compounds represented by the following formulas (I) to (VI): 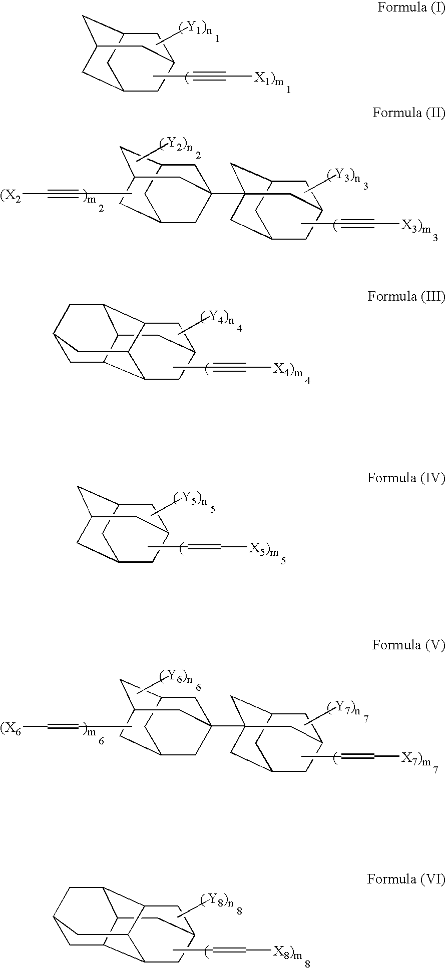
wherein, X₁(s) to X₈(s) each independently represents a hydrogen atom, C₁₋₁₀ alkyl group, C₂₋₁₀ alkenyl group, C₂₋₁₀ alkynyl group, C₆₋₂₀ aryl group, C₀₋₂₀ silyl group, C₂₋₁₀ acyl group, C₂₋₁₀ alkoxycarbonyl group, or C₁₋₂₀ carbamoyl group;
Y₁ to Y₈ each independently represents a halogen atom, C₁₋₁₀ alkyl group, C₆₋₂₀ aryl group or C₀₋₂₀ silyl group;
m₁ and m₅ each represents an integer of 1 to 16;
n₁ and n₅ each represents an integer of 0 to 15;
m₂, m₃, m₆ and m₇ each independently represents an integer of 1 to 15;
n₂, n₃, n₆ and n₇ each independently represents an integer of from 0 to 14;
m₄ and m₈ each independently represents an integer of 1 to 20; and
n₄ and n₈ each represents an integer of 0 to 19.

8. The production method according to claim 4,
wherein the cage structure is formed by linking each of m pieces of RSi(O_{0.5})₃ units with other RSi(O_{0.5})₃ units by sharing the oxygen atoms,
wherein m represents an integer from 8 to 16; and
each of Rs represents a non-hydrolyzable group, with the proviso that each of at least two Rs represents a group having a vinyl group or ethynyl group.

9. The production method according to claim 8,
wherein the monomer having a cage structure is selected from the group consisting of compounds represented by the following formulas (Q-1) to (Q-6): 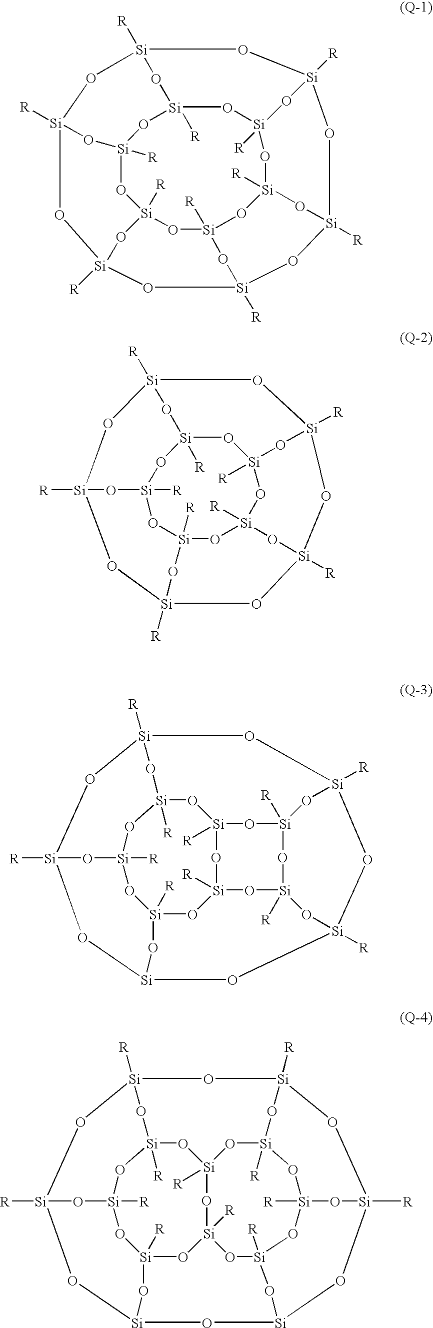 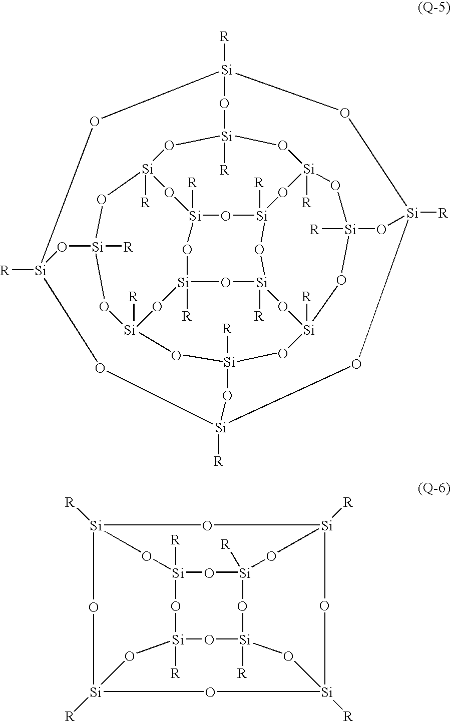
wherein each of Rs represents a non-hydrolyzable group, with the proviso that each of at least two Rs in each of formulas (Q-1) to (Q-6) represents a group having a vinyl group or ethynyl group.

10. An insulating film forming composition produced by the production method according to claim 1.

11. An insulating film formed by using the insulating film forming composition according to claim 10.

12. An electronic device comprising the insulating film according to claim 11.
